(19) United States
(12) Patent Application Publication
(10) Pub. No.: US 2009/0142455 A1
(43) Pub. Date: Jun. 4, 2009

(54) DESSERT FOOD PACKAGE

(75) Inventor: Steven Parsons, St. Alberta (CA)

Correspondence Address: Merchant & Gould - ConAgra, P.O. Box 2903, Minneapolis, MN, 55402, US

(73) Assignee: ConAgra Foods RDM, Inc., Omaha, NE (US)

(21) Appl. No.: 12/277,886

(22) Filed: Nov. 25, 2008

Related U.S. Application Data
(60) Provisional application No. 60/991,173, filed on Nov. 29, 2007.

(51) Int. Cl. A23L 3/36

(52) U.S. Cl. 426/120; 426/412; 426/393

(57) ABSTRACT

A food tray and a method of using the food tray to prepare foods at different temperatures for consumption are provided. The food tray comprises an outer bowl, an inner bowl, and wrapping. The outer bowl contains a first food product, and the inner bowl contains a second food product. The Inner bowl is at least partly nested within the outer bowl and is removable from the outer bowl. At least one of the first food product and the second food product comprise a dessert. The other of the first food product and the second food product comprise a topping for the dessert. The wrapping is positioned around both the outer bowl and the inner bowl to form an integrated food tray at a point of sale.

### CROSS-REFERENCE TO RELATED APPLICATION

This application claims the benefit of U.S. Provisional Patent Application Ser. No. 60/991,173, filed Nov. 29, 2007, which application is hereby incorporated by reference in its entirety.

### TECHNICAL FIELD

Packaged food products.

### BACKGROUND

United States Patent Publication No. US 2007-0116807 published May 24, 2007, discloses a food tray comprising a lower tray and an upper tray containing separate food products.

### SUMMARY

A food tray is provided comprising an outer bowl, an inner bowl, and wrapping. The outer bowl contains a first food product, and the inner bowl contains a second food product. The inner bowl is at least partly nested within the outer bowl and is removable from the outer bowl. At least one of the first food product and the second food product comprise a dessert. The other of the first food product and the second food product comprises a topping. The wrapping is positioned around both the outer bowl and the inner bowl to form an integrated food tray at a point of sale.

A method is provided for preparing foods at different temperatures for consumption. A food tray is provided comprising an outer bowl and an inner bow. The outer bowl contains a first food product, and the inner bowl contains a second food product. The inner bowl is at least partly nested within the outer bowl. At least one of the first food product and the second food product comprises a dessert. The other of the first food product and the second food product comprises a topping. The inner bowl is separated from the outer bowl. The one of the inner bowl or the outer bowl containing the other of the first food product and the second food product that comprises the topping is then heated.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a top plan view of an outer bowl of a food tray.

FIG. 2 is a top plan view of an inner bowl of a food tray.

FIG. 3 is a top plan view, partially in section, a food tray comprising the inner bowl of FIG. 2 positioned within the outer bowl of FIG. 1.

FIG. 4 is top plan view of the food tray of FIG. 3 comprising an additional container.

FIG. 5 is a side elevation view, partially in section, of the food tray of FIG. 3 containing a first food product and a second food product.

FIG. 6 is a flow diagram of a method of preparing foods at different temperatures for consumption.

FIG. 7 is a flow diagram of a method of preparing foods at different temperatures for consumption and adding the foods together.

FIG. 8 is a flow diagram of a method of preparing foods stored in a frozen state at different temperatures for consumption.

### DETAILED DESCRIPTION

In the claims, the word “comprising” is used in its inclusive sense and does not exclude other elements being present. The indefinite article “a” before a claim feature does not exclude more than one of the feature being present. Each one of the individual features described here may be used in one or more embodiments and is not, by virtue only of being described here, to be construed as essential to all embodiments as defined by the claims.

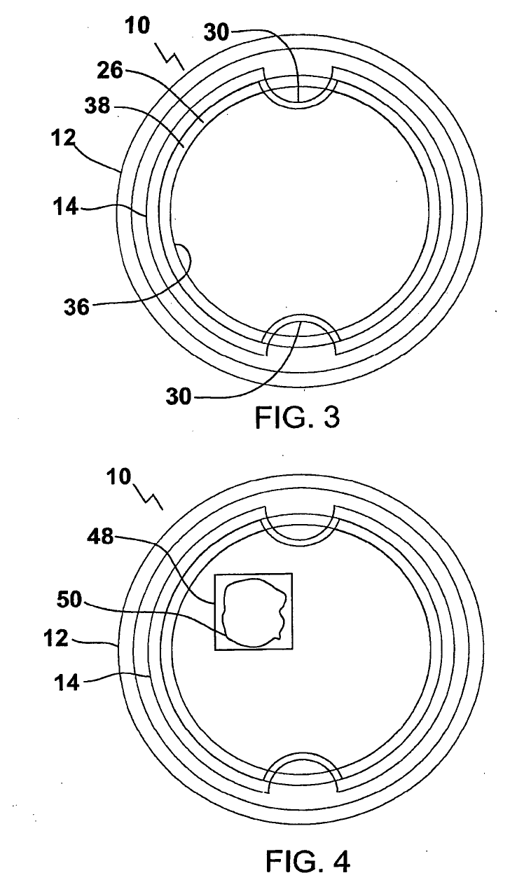

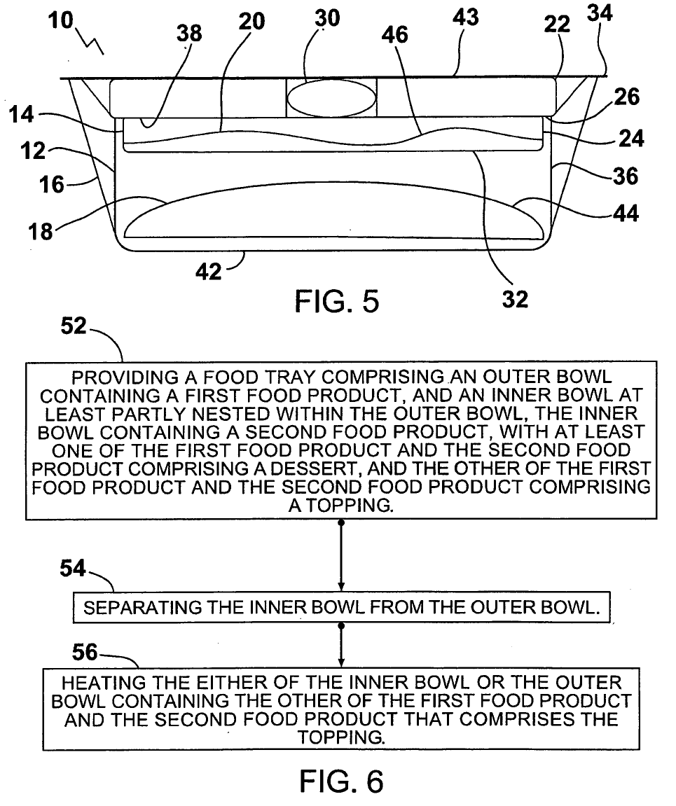

Referring to FIG. 5, a food tray 10 comprises an outer bowl 12 and an inner bowl 14. The bowls may be round as shown, but could be any suitable shape such as rectangular, with rounded edges. Food tray 10 may also be provided with wrapping 43 around both outer bowl 12 and inner bowl 14 to form an integrated food tray at a point of sale. Outer bowl 12 may contain a first food product 18. Referring to FIGS. 3 and 5, inner bowl 14 may be nested at least partly within outer bowl 12. Inner bowl 14 may be removable from outer bowl 12. Referring to FIG. 5, inner bowl 14 may contain a second food product 20. First food product 18 and second food product 20 may be frozen food products. In one embodiment, second food product 20 is positioned entirely within inner bowl 14. Food tray 10 may be configured for preparing foods at different temperatures for consumption.

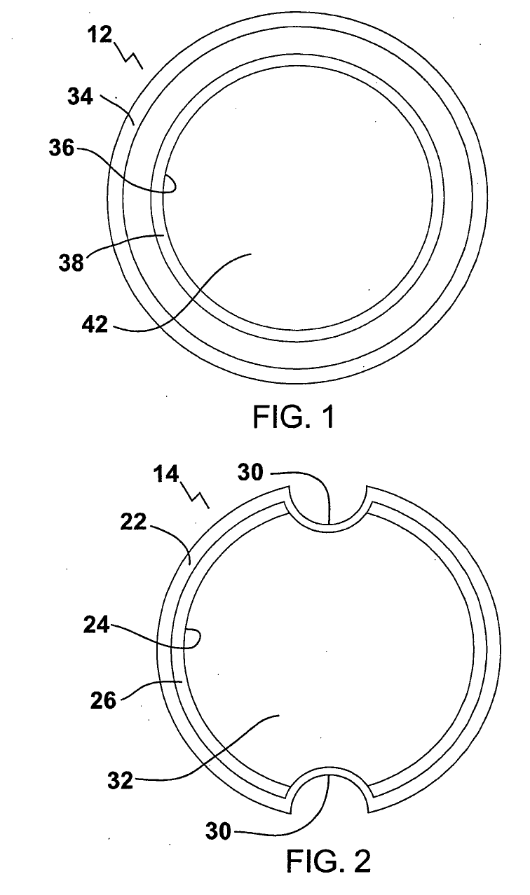

Referring to FIGS. 2 and 5, inner bowl 14 may comprise a lip 22, a sidewall 24, an outer ledge 26, indents 30, and a base 32. Referring to FIGS. 1 and 5, outer bowl 12 may comprise a lip 34, a sidewall 36, an interior shoulder 38, and a base 42. Referring to FIG. 5, lips 22 and 34 may provide a surface for food tray 10 to be sheet sealed. Each of outer bowl 12 and inner bowl 14 may be individually sheet-scaled. If lips 22 and 34 are provided at the same height, a single sheet may be used to seal both of outer and inner bowls 12 and 14, respectively. Alternatively, only outer bowl 12 may be sealed, with inner bowl 14 being nested entirely within outer bowl 12. Referring to FIGS. 3 and 5, outer ledge 26 may rest upon interior shoulder 38 of outer bowl 12. If no interior shoulder 38 is provided on outer bowl 12, outer ledge 26 may rest upon sidewall 36. Referring to FIG. 3, indents 30 allow fingers to easily remove inner bowl 14 from outer bowl 12. Either or both of outer and inner bowls 12 and 14, respectively, may be provided as trays. Outer and inner bowls 12 and 14, respectively, may have any suitable shape.

Referring to FIG. 5, at least one of first food product 18 and second food product 20 may be provided as a dessert. In some embodiments the dessert is frozen. The other of first food product 18 or second food product 20 is a topping for the dessert and may contain a sweetener and may be a liquid at room temperature. The topping may comprise a fluid that reduces in viscosity when heated. In further embodiments, first food product 18 may be intended for consumption with second food product 20 at a first temperature that is at or below room temperature. Similarly, second food product 20 may be intended for consumption at a second temperature that is above the first temperature. In some embodiments, first food product 18 may comprise ice cream, gelato, ice milk, cake or frozen yogurt. Second food product 20 may be a sauce 46. Sauce 46 may comprise for example chocolate sauce, raspberry sauce, caramel sauce, maple syrup, blueberry sauce, fruit sauce or vanilla sauce. Second food product may also comprise one or more of cobbler, crumble, fudge, chunks of brownie, cookie dough, or fruit pieces. In some embodiments other types of sauces may be used. Food tray 10 containing first and second food products 18 and 20, respectively may be stored below room temperature for example in a freezer.

In one embodiment, either or both of outer and inner bowls 12 and 14, respectively, are constructed from material that is suitable for heating in an oven. In one embodiment, only the one of the outer or inner bowls 12 and 14, respectively, that contains the topping is constructed from material that is suitable for heating in an oven. Examples of materials suitable for heating in an oven comprise polypropylene (microwave only) and dual use CPET (crystalline polyethylene terephthalate). Dual use CPET is available from a number of manufacturers. CPET is particularly suitable due to its wide temperature tolerance. Either or both of outer and inner bowls 12 and 14, respectively, may be formed from injection moulding, thermoforming or any other suitable manufacturing process. Either or both of outer and inner bowls 12 and 14, respectively, may be transparent or opaque. Examples of a suitable type of oven that may be used comprises a conventional oven, a convection oven, or a microwave oven.

Referring to FIG. 4, in one embodiment, food tray 10 may comprise an additional container 48. Container 48 may be at least partly nested within outer bowl 12. In some embodiments, container 48 may be at least partly nested within both outer and inner bowls 12 and 14, respectively. Container 48 may contain a third food product 50. Third food product 50 may comprise a second topping for first food product 18 (shown in FIG. 5). The second topping may comprise chopped nuts, sprinkles, candy, chocolate chips, icing, whipped cream, or a sauce. Alternatively, other types of second toppings may be provided in container 48. Container 48 may be individually sealed, or may be sealed with the same sheet that seals at least inner bowl 14.

Food tray 10 may comprise a cover (not shown) for at least outer bowl 12. Inner bowl 14 may be provided with a cover. In one embodiment, the cover may comprise a cardboard sleeve into which the combined bowls 12 and 14 are inserted. The cover may also be a carton that encloses both bowls 12 and 14 completely. In other embodiments, the cover may be provided as a clip-on cover. Referring to FIG. 5, in further embodiments, food tray 10 may be provided in a sealed package 16.

Referring to FIG. 6, a method is illustrated. This method may be a method of preparing foods at different temperatures for consumption. In step 52, food tray 10 is provided according to any of the embodiments of food tray 10 described herein. Referring to FIG. 5, an example of food tray 10 is illustrated with ice cream 44 contained within outer bowl 12 and sauce 46 contained within inner bowl 14. Referring to FIG. 6, in step 54 inner bowl 14 is removed from outer bowl 12. Referring to FIG. 3, this may be accomplished by gripping indents 30 of inner bowl 14 and removing inner bowl 14 from outer bowl 12. Referring to FIG. 6, in step 56 the one of the outer or inner bowls 12 and 14, respectively that contains the food product containing the topping is heated. Referring to FIG. 5, one example of this step may include removing and heating inner bowl 14 containing sauce 46. If container 48 is provided, it may be heated along with, or separate from, inner bowl 14. In one embodiment, container 48 and inner bowl 14 are both removed from outer bowl 12 and heated. In another embodiment, container 48 is removed but not heated.

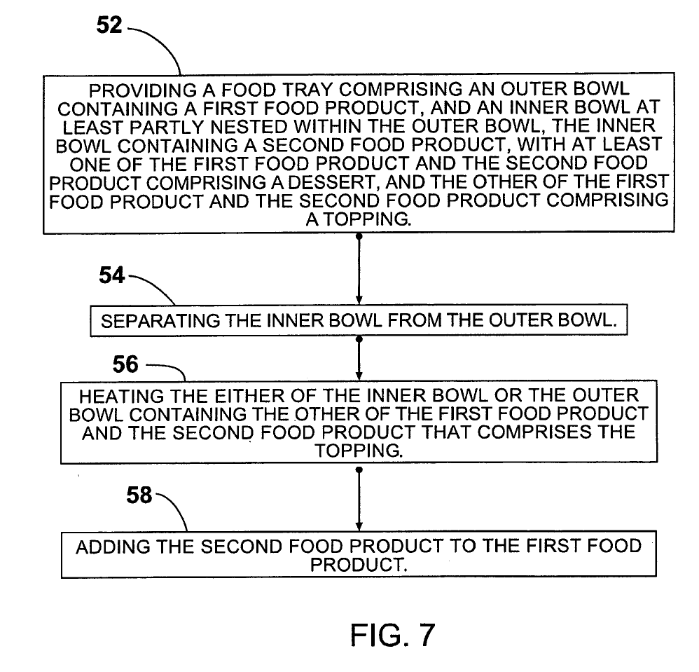

Referring to FIG. 7, another embodiment of the method detailed in FIG. 6 is illustrated. In step 58, second food product 20 is added to first food product 18. Referring to FIG. 5, after heating inner bowl 14 containing sauce 46, the heated sauce 46 is then poured overtop of ice cream 44. Referring to FIG. 4, if container 48 is provided, third food product 50 may be added to ice cream 44. Third food product 48 may be added in a heated or non-heated state.

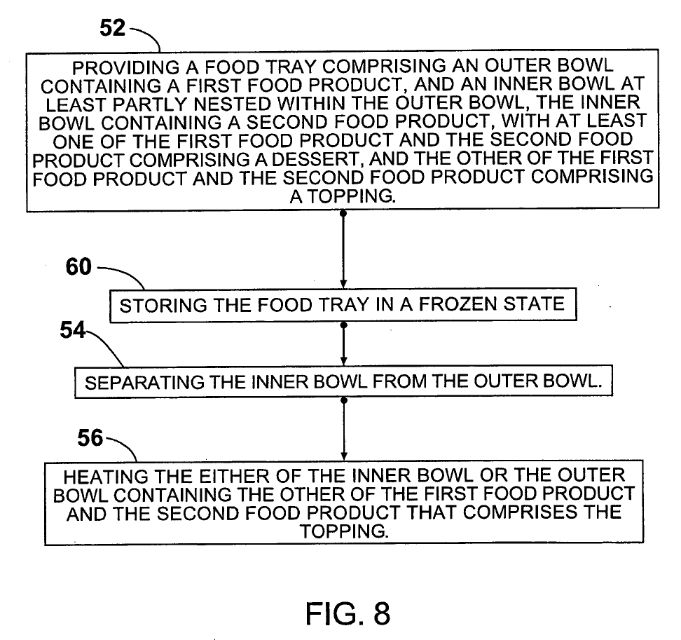

Referring to FIG. 8, a further embodiment of the method described in FIG. 6 is illustrated. In step 60, food tray 10 is stored in a frozen state. Step 60 is positioned prior to steps 54 and 56. An example of step 60 includes storing food tray 10 in a freezer. This allows a tasty ice cream treat with heated sauce and optional toppings to be prepared conveniently and easily in seconds. The only equipment necessary is an oven, preferably a microwave oven.

Immaterial modifications may be made to the embodiments described here without departing from what is covered by the claims.

Various modifications and alterations of this disclosure will become apparent to those skilled in the art without departing from the scope and spirit of this disclosure, and it should be understood that the scope of this disclosure is not to be unduly limited to the illustrative embodiments set forth herein.

What is claimed is:

1. A food tray, comprising:
an outer bowl containing a first food product;
an inner bowl at least partly nested within the outer bowl and being removable from the outer bowl, the inner bowl containing a second food product;
at least one of the first food product and the second food product comprises a dessert, and the other of the first food product and the second food product comprises a topping for the dessert; and wrapping around both the outer bowl and the inner bowl to form an integrated food tray at a point of sale.

2. The food tray of claim 1 wherein the first food product and the second food products are frozen food products.

3. The food tray of claim 1 wherein the topping comprises a fluid that reduces in viscosity when heated.

4. The food tray of claim 1 wherein the topping comprises a sweetener.

5. The food tray of claim 1 wherein the first food product comprises ice cream, ice milk, gelato, cake or frozen yoghurt.

6. The food tray of claim 1 wherein the second food product is a sauce.

7. The food tray of claim 1 wherein the sauce comprises one or more of chocolate sauce, raspberry sauce, caramel sauce, maple syrup, blueberry sauce, fruit sauce or vanilla sauce.

8. The food tray of claim 1 wherein the second food product comprises one or more of cobbler, crumble, fudge, chunks of brownie, cookie dough, or fruit pieces.

9. The food tray of claim 1 wherein the second food product is contained in the inner bowl and the inner bowl is made of a material suitable for heating in an oven.

10. The food tray of claim 1 wherein the second food product is contained in the outer bowl and the outer bowl is made of a material suitable for heating in an oven.

11. The food tray of claim 1 further comprising an additional container that is at least partly nested within the outer bowl, the additional container containing a third food product.

12. The food tray of claim 11 wherein the third food product comprises a second topping for the first food product.

13. The food tray of claim 12 wherein the second topping comprises chopped nuts, sprinkles, candy, chocolate chips, icing, whipped cream, or sauce.

14. A method comprising:
providing a food tray comprising an outer bowl containing a first food product, and an inner bowl at least partly nested within the outer bowl, the inner bowl containing a second food product, with at least one of the first food product and the second food product comprising a dessert, and the other of the first food product and the second food product comprising a topping;
separating the inner bowl from the outer bowl; and
heating the one of the inner bowl and the outer bowl that contains the topping.

15. The method of claim 14 further comprising the step of adding the second food product to the first food product subsequent to the heating step.

16. The method of claim 14 wherein the second food product is positioned entirely within the inner bowl.

17. The method of claim 14 wherein the first food product comprises one or more of ice cream, ice milk, gelato, cake or frozen yoghurt.

18. The method of claim 14 wherein the second food product comprises one or more of chocolate sauce, raspberry sauce, caramel sauce, maple syrup, blueberry sauce, fruit sauce or vanilla sauce.

19. The method of claim 14 wherein the second food product comprises one or more of cobbler, crumble, fudge, chunks of brownie, cookie dough, or fruit pieces.

20. The method of claim 14 further comprising the step of storing the food tray in a frozen state.

21. A food tray for preparing foods at different temperatures for consumption comprising:
an outer tray;
an inner tray, the inner tray positioned at least partly within the outer tray;
a first food product intended for consumption at a first temperature that is at or below room temperature; and a second food product intended for consumption at a second temperature that is above the first temperature;
wherein one of the first food product or the second food product is positioned within the outer tray, with the other of the first food product or the second food product positioned within the inner tray, and in which the one of the inner tray or outer tray containing the second food product is configured to be separated from the other of the inner tray or outer tray and heated.

22. The food tray of claim 21, wherein the first and second food products are stored at or below room temperature.

23. The food tray of claim 21 wherein at least one of the first food product and the second food product comprises a dessert, and the other of the first food product and the second food product comprises a topping.
